(19) United States
(12) Patent Application Publication
(10) Pub. No.: US 2010/0154248 A1
(43) Pub. Date: Jun. 24, 2010

(54) DRYER WITH HEAT PUMP AND RECIRCULATION COMPONENT AND ALSO METHOD FOR ITS OPERATION

(75) Inventor: Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GmbH, Munich (DE)

(21) Appl. No.: 12/636,826

(22) Filed: Dec. 14, 2009

(30) Foreign Application Priority Data
Dec. 22, 2008 (DE) 10 2008 055 087.6

(51) Int. Cl. F26B 3/02; F26B 21/06; F26B 25/06

(52) U.S. Cl. 34/493; 34/77; 34/218

(57) ABSTRACT

A dryer includes a drying chamber for the items to be dried, an inlet air duct, a process air duct, an exhaust air duct, a recirculating air duct, a fan, and a heat pump with an evaporator, a condenser and a programmable controller. The dryer defines a process air path for obtaining and maintaining a predetermined minimum difference ΔT^{set} between an evaporator entry temperature T₂ and a dryer entry temperature T₁ as well as a predetermined lower threshold T₂^{set} for the evaporator entry temperature.

### BACKGROUND OF THE INVENTION

The invention relates to a dryer with a heat pump and recirculation component and also to a preferred method for its operation.

In general tumble dryers are operated as vented-air or condenser dryers. Condenser dryers which operate on the basis of condensing out of the laundry moisture evaporated by means of warm process air make it possible to recover energy from the heated process air, by using a heat pump for example. The condensate arising in the condenser dryer is collected and either pumped away or disposed of by manually emptying a drainage container.

With vented-air dryers on the other hand, moisture-laden air is generally taken out of the dryer after passing through a laundry drum. There is frequently no heat recovery here.

Vented-air dryers with heat recovery are known however. Thus publication DE 30 00 865 A1 describes a tumble dryer with heat recovery. The tumble dryer consists of a container which moves and holds the laundry into which a flow of inlet air heated by a heating element emerges while the moist warm air is guided via an outlet as exhaust air. Arranged in the inlet air flow in front of the heating element is a heat exchanger through which the moist-warm exhaust air from the container passes.

DE 40 23 000 C2 describes a tumble dryer with a heat pump circuit, in which an inlet air opening is arranged in the process air duct between the condenser and the evaporator which is able to be closed off by a controllable closure facility.

DE 197 31 826 A1 describes a tumble dryer with a system for heat feedback (e.g. a heat pump) in which at two predetermined points the largely self-contained air circuit can exchange the circulating air for air from the room through two openings, in order to keep the drying and condensation temperature at the predetermined values.

DE 43 06 217 B4 discloses a programmable tumble dryer with a laundry drum, in which the process air is conveyed through the laundry drum by a fan in a closed process air duct which has closure facilities. The tumble dryer also features a heat pump circuit comprising evaporator, compressor and condenser for removing the moisture in the process air from the laundry drum. The closure facilities are arranged so that the guidance of the process air depends on a process phase.

With a vented-air dryer with a heat pump heat is extracted by the evaporator of the heat pump and is then fed back via the condenser into the inlet air. Since the vented-air dryer is an open system, by contrast with a condenser dryer with a closed process air circuit, sensible heat as well as latent heat is also recovered. This means that a vented-air dryer with heat recovery, despite a condensation efficiency of for example less than 50%, can have a lower energy consumption than a condenser dryer. Depending on the efficiency of the heat pump, heat is coupled in from the surroundings of the heat pump. However a higher condensation efficiency would be desirable for a more efficient operation.

It is also known that the energy efficiency of a vented-air dryer can be improved by an air recirculation system. In such cases some of the process air laden with moisture from the laundry in the drying chamber is fed back to the drying process via the heater.

DE 103 49 712 A1 describes a method for drying laundry in a tumble dryer with a programmable control, a drying chamber and a process air duct, in which a fan for conveying the dry air through the drying chamber and also a heating device are arranged, with the process air duct being embodied with a fresh air inlet and an exhaust air outlet and with means being arranged in the process air duct for dividing the drying air flow into an exhaust air component and a recirculation component.

According to its claim 1, DE 34 46 468 A1 discloses a method for drying laundry in a tumble dryer with a drivable laundry drum, a fan, a heater arranged in the flow path of the drying air and also a cooled condenser, via which the drying air is routed after leaving the laundry drum, with the drying air being split up into two part air flows after it leaves the laundry drum. The one part air flow is fed to the condenser and the other bypasses the condenser and is mixed back into the part air flow leaving the condenser.

DE 34 19 743 C2 describes a tumble dryer with a laundry drum, a heater unit provided with an inlet air connection and also an outlet air connection, whereby different supplementary units defining the mode of operation of the tumble dryer are to be arranged for connection between inlet air connection of the heater unit and outlet air connection. In one embodiment of the dryer a recirculation part is connected between the inlet connection flange and the outlet flange in which a air control device is located by which the ratio of inlet air to outlet air of the dryer can be varied. This gives the option of a winter-summer switchover. In winter mode cold air is supplied from outside and fed into the dryer. The warm exhaust air of the dryer comes out into the room in which the dryer is sited and contributes to heating up the air in the room.

The non-prior published DE 10 2008 035797 A1 describes a clothing handling device with a cabinet with a space to hold laundry; an air supply device which delivers hot air to the space and a control unit that determines the dryness of the laundry on the basis of the temperature difference measured at two sensors in order to control the air supply device. The sensors can include a first sensor that measures the temperature of the air sucked into the holder and a second sensor that measures the air released from the holder. The air supply device can be configured with a heat pump with an evaporator, a compressor, a condenser and a pressure-relief valve.

The non-prior published DE 10 2007 042969 A1 describes a dryer with a drying chamber for items to be dried, a process air duct in which a heating element for heating up the process air and a fan for guiding the heated process air from an inlet air entry through the drying chamber to an outlet air exits as well as at least one heat exchanger are located. The heat exchanger is arranged between the drying chamber and the outlet air exit. A recirculation air duct branches off from the process air duct behind the drying chamber, through which a part of the process air is able to be fed to the heating element. The at least one heat exchanger can be formed by an evaporator and a condenser of a heat pump.

CH 690 038 A5 describes a tumble dryer cabinet with a drying chamber and an equipment section with a heat pump comprising an evaporator, a compressor and a condenser, and a recirculating ventilator for circulation of the air in the tumble dryer cabinet. The tumble dryer cabinet additionally features an inlet air ventilator for supplying outside air into the tumble dryer cabinet and an exhaust air valve for venting the air from the tumble dryer cabinet. Maintaining a specific temperature in the tumble dryer cabinet is seen as decisive for obtaining a high efficiency.

### BRIEF SUMMARY OF THE INVENTION

An exemplary embodiment of the present invention provides a vented-air tumble dryer with high energy efficiency that uses a proportion of recirculated air and overcomes the disadvantages of too low a level of condensation efficiency. An object of an exemplary embodiment of the present invention is also to provide a method for its operation.

An exemplary embodiment of the invention is a dryer with a drying chamber for the items to be dried, in inlet air duct, a process air duct, an exhaust air duct and recirculating air duct, a fan, a heat pump with an evaporator and a condenser as well as a programmable control, with the dryer comprising a process air path arrangement for obtaining and maintaining a predetermined minimum difference ΔT^{set} between an evaporator entry temperature T₂ and a dryer entry temperature T₁ as well as a predetermined lower threshold T₂^{set} for the evaporator entry temperature.

The predetermined minimum difference ΔT^{set} between an evaporator entry temperature T₂ and a dryer entry temperature T₁ preferably lies in the range 25 to 55° C., more preferably in the range from 30 to 50° C. and especially preferably in the range from 35 to 45° C.

The dryer entry temperature T₁ generally ranges from 15 to 35° C. and preferably ranges from 19 to 25° C.

Preferred evaporator entry temperatures thus typically lie in the range from 50 to 70° C., especially in the range from 55 to 65° C.

Temperatures T₁ and/or T₂ will generally be measured by means of a suitable temperature sensor in the inlet air entry and/or directly before the evaporator. The temperature values are then generally fed to a program controller which in preferred embodiments can control the circulating air and exhaust air.

In a exemplary embodiment of the dryer there is a connection point in the process air path arrangement of recirculating air duct with inlet air duct between the condenser and an inlet air entry. Surprisingly this achieves an increase of the volume flow of the process air and of the efficiency of the condenser, with the entry temperature in the evaporator still being increased. The higher moisture content of the process air linked to the higher evaporator entry temperature T₂ can lead to the condensation efficiency rising to over 80%. The proportion of sensible heat of the process air does reduce, but still contributes sufficiently to improving the energy consumption of the dryer.

In a further exemplary embodiment the condenser is located in the process path arrangement between a connection point from recirculating air duct with inlet air duct and an inlet air access. Because of the increase in the temperature of the process air after the mixing of inlet air and recirculating air and thereby an increase in a drum entry temperature, the evaporator entry temperature T₂ also increases.

In general a condenser that is adapted to the lower volume flows of the process air is used in this embodiment. A particular advantage of this embodiment is that the condenser is protected from lint contamination.

Both above-mentioned embodiments generally lead to a reduced volume flow of the process air over the condenser so that this unit tends to be less contaminated.

A first controllable closure facility is preferably located in the recirculating air duct and a second controllable closure facility is preferably located in the inlet air duct. Finally a third controllable closure facility is preferably located in the exhaust air duct. In this way the proportions of air flowing in these ducts can be controlled. Flaps can typically be used as the controllable closure facility which can be opened to different degrees independently or depending on one another.

Preferably an outlet vent opening is arranged in the process air path arrangement in the process air duct before the drying chamber. In this case the fan is generally arranged in the direction of the flowing process air before the drying chamber. The outlet vent opening can preferably be opened and closed via a fourth controllable closure device to a differing extent.

The process air path arrangements in the inventive dryer are preferably designed so that they bring about condensation efficiency of at least 70% and especially of at least 80%.

The dryer preferably includes an electrical heater so that process air can be heated up both by means of the condenser and also by means of the electrical heater. Since as the degree of drying of the items to be dried in the dryer increases, the necessary energy for drying decreases, it is expedient to regulate the heating accordingly, i.e. to reduce its heat output as the degree of drying progresses. In the dryer of the present invention the proportion of recirculating air can also be reduced as a function of the temperature if the condenser entry temperature is too high.

By using a recirculating air duct or by the passage of the hot moisture-laden recirculating air through the recirculating air duct to the heater the air temperature before the heater is generally increased. Because of the increased air flow over the heater however the drum temperature can remain in the permitted range. To achieve and maintain, in accordance with the present invention, a desired difference ΔT^{set} between the evaporator entry temperature T₂ and the dryer entry temperature T₁, with the evaporator entry temperature not falling below a predetermined lower threshold T₂^{set}, the air flow of the exhaust air, the recirculating air and/or the inlet air can be regulated, for example by using a first controllable closure facility in the recirculating air duct and/or a second controllable closure facility in the inlet air duct. To speed up the heating of the process air after the dryer is switched on, the quantity of inlet air through the second controllable closure facility in the inlet air duct can be controlled so that the supply of inlet air is stopped and the device only operates with recirculating air as process air.

Inventively it is preferable for exhaust air, inlet air and/or coolant to each be guided in a crossflow or counterflow method through the corresponding heat exchanger.

The evaporator of the heat pump is generally in contact with the exhaust air duct, in order to extract heat from the moist-warm air from the drying chamber which generally flows via the outlet air duct into the room where the dryer is sited.

With a dryer equipped with a heat pump the warm, moisture-laden process air is generally cooled in the evaporator of the heat pump, where the transferred heat will be used for evaporating a coolant used in the heat pump circuit. The coolant of the heat pump evaporated as a result of the heating is fed via a compressor to the condenser of the heat pump, where, as a result of the condensation of the gaseous coolant, heat is released that is used to heat up the process air or the exhaust air before it enters the drying chamber.

The fan is preferably arranged directly after the condenser or directly before the condenser.

The invention also comprises a method for operating a dryer with a drying chamber for the items to be dried, an inlet air duct, a process air duct, an exhaust air duct, a recirculating air duct, a heat pump with an evaporator and a condenser and also a programmable controller, with the dryer including a process air path arrangement for achieving and maintaining a predetermined minimum difference ΔT^{set} between and evaporator entry temperature T₂ and a dryer entry temperature T₁ as well as a predetermined lower threshold T₂^{set} for the condenser entry temperature, with process air being directed through the inlet air duct and split up into a first part flow in the recirculating air duct and into a second part air flow in the exhaust air duct so that a minimum difference ΔT^{set}=(T₂−T₁) between an evaporator entry temperature T₂ a dryer entry temperature T₁ is obtained and maintained and a predetermined lower threshold T₂^{set} for the condenser entry temperature is obtained and maintained.

In an exemplary embodiment of this method a volume ratio between the first part air flow and the second part air flow lies in the range 1.5 to 10, and especially preferably in the range 3 to 8.

In addition it is preferable for the first part air flow to amount to 200 to 300 m³/h. The second part air flow preferably amounts to less than 100 m³/h. Especially preferably the second part air flow in the exhaust air duct amounts to 40 to 80, especially 50 to 70 m³/h.

Preferably an outlet vent opening is at least partly opened in the inventive method for obtaining the minimum difference ΔT^{set}=(T₂−T₁) and lower threshold T₂^{set} for the evaporator entry temperature. The venting is preferably undertaken explicitly by the outlet vent opening being opened at specific times or on reaching a predetermined lower threshold for an evaporator entry temperature. The result of the venting can be that the air temperature before the evaporator does not fall too much. Since this guidance of the process air is comparatively unfavorable, the vented air amount is preferably adapted to a desired condensation rate. The energy loss can however be smaller than the recovered sensible energy, so that overall a reduced energy consumption of the dryer results.

This dryer has the advantage that it can operate in an energy-efficient manner with a high condensation efficiency.

### BRIEF DESCRIPTION OF THE DRAWINGS

Further details of the invention emerge from the following description of non-restrictive exemplary embodiments for the inventive dryer and a method using this dryer. In this case reference is made to the FIGS. 1 to 3 of the enclosed drawing. The figures show:

FIG. 1 a vertical section through a dryer in accordance with a first embodiment, in which a condenser is located between a point connecting recirculating air duct to inlet air duct and an inlet air access;

FIG. 2 a vertical section through a dryer in accordance with a second embodiment, in which a condenser is located between a point connecting recirculating air duct to inlet air duct and an inlet air access; and

FIG. 3 a vertical section through a dryer in accordance with a third embodiment, in which a point connecting the recirculating air duct to the inlet air duct is located between a condenser and an inlet air access.

### DETAILED DESCRIPTION OF EXEMPLARY EMBODIMENTS OF THE PRESENT INVENTION

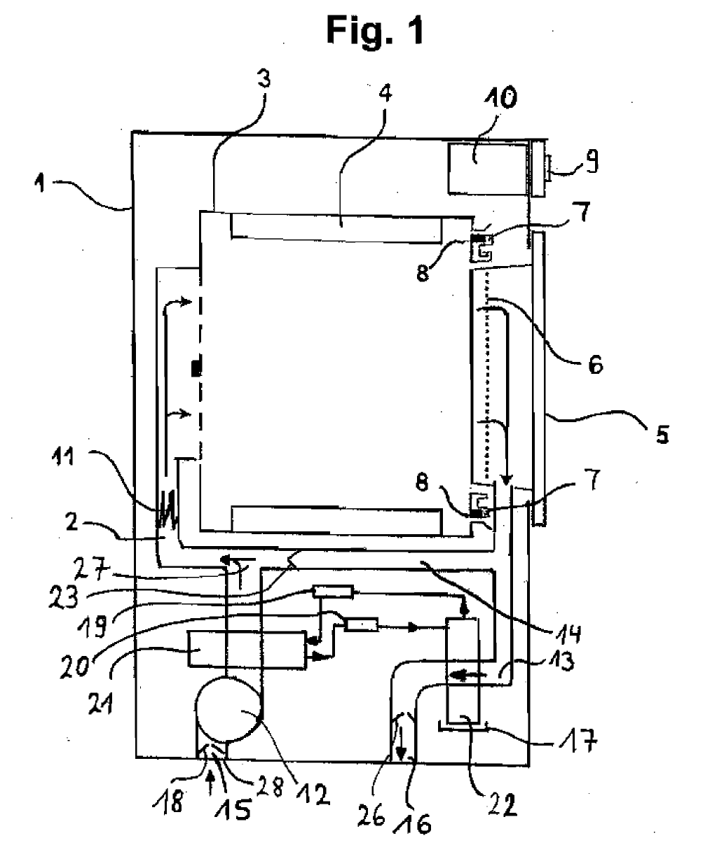

FIG. 1 shows a vertical section through a dryer in accordance with a first embodiment, in which a condenser 21 is located between a point 27 connecting recirculating air duct 14 to inlet air duct 15 and an inlet air access 28.

The dryer 1 shown in FIG. 1 has a drum able to be rotated around a horizontal axis as its drying chamber 3, within which agitators 4 for moving washing during a drum rotation are attached. Process air is guided by means of a fan 12 via an electric heater 11 and through a drum 3 in a process air duct 2. Starting from an inlet air entry 28, air from the room is fed via an inlet air duct 15 into the process air duct 2 or is sucked in by the fan 12. After passing through the drum 3 the process air duct 2 splits into a recirculating air duct 14 and an exhaust air duct 13, so that the moist, warm process air is divided up into a recirculating air flow in the recirculating air duct 14 and an exhaust air flow in the exhaust air duct 13.

In the exhaust air duct the warm moisture-laden process air from the drum 3 reaches the evaporator 22 of a heat pump circuit 19, 20, 21, 22. The cooled process air is then conducted via an exhaust air outlet 16 into the room air. The condensate arising in the evaporator is caught in a condensate tray 17, from where it can be disposed of by emptying the tray or pumping it away. The coolant of the heat pump evaporated in the evaporator 22 is conveyed via a compressor 19 to the condenser 21. In the condenser 21 the coolant condenses while giving off heat to the process air coming from the inlet air entry 28 in the inlet air duct 15. The coolant now present in liquid form is again conveyed via a choke valve 20 to the condenser 22, which closes the coolant circuit. A part of the warm, moisture-laden process air emerging from the drying chamber 3 is split off into a recirculating air duct 14 and conducted via the heater 11 back into the drying chamber 3 again.

In the dryer 1 the air heated by the heater 11 is conveyed from the rear, i.e. from the side of the drum 3 lying opposite the door 5, through its perforated floor into the drum 3, comes into contact there with the laundry to be dried and flows through the filler opening of the drum 3 to a lint filter 6 within a door 5 closing off the filler opening. Subsequently the process air flow is diverted downwards in the door 5. The room air supplied as inlet air to the dryer 1 via the inlet air duct 15 is heated up by the condenser 21 and subsequently once again by the heater 11 before entering the drying chamber 3.

In the embodiment shown in FIG. 1 the separated process air from the recirculating air duct 14 and the inlet air preheated in the condenser 21 are combined before the electrical heater 11. The recirculating air flow can be controlled by a first controllable closure facility 23 and the inlet air flow by a second controllable closure facility. Finally the exhaust air flow can be controlled by a third controllable closure facility 26. Flaps can be used for example as controllable closure facilities, which are able to be opened by different amounts independently or depending on one another.

The drum 3 in the exemplary embodiments shown in FIGS. 1 through 3 is supported on the rear base by means of a rotary bearing and at the front by means of an end bearing shield 7, with the drum 3 resting with a flange on a slider strip 8 on the end shield 7 and being held in this way at its front end The condenser dryer 10 is controlled via a controller 10 which can be regulated by the user via a control unit 9.

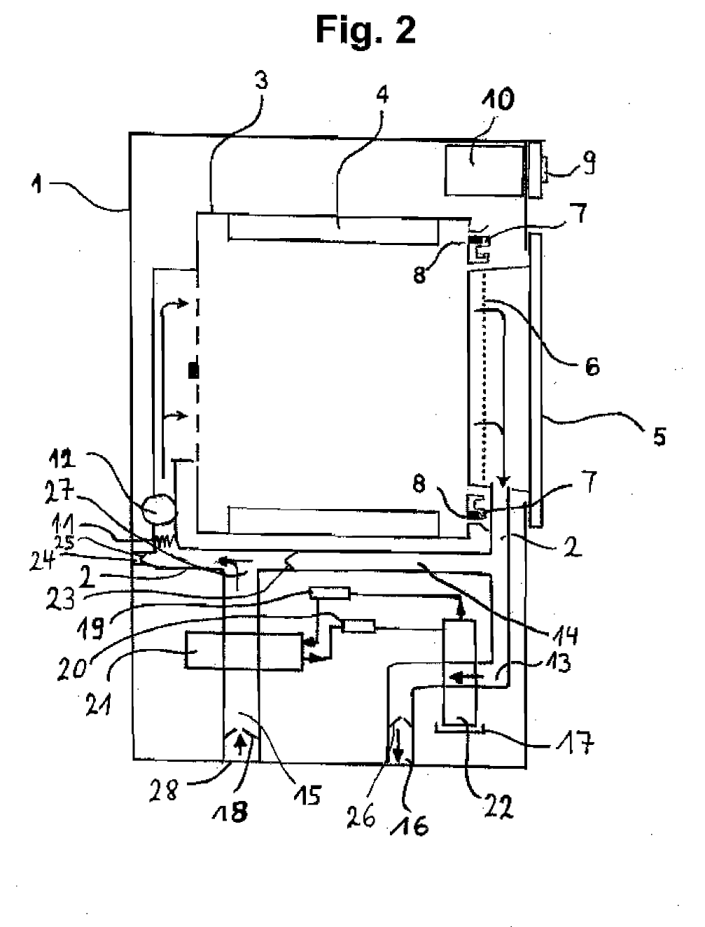

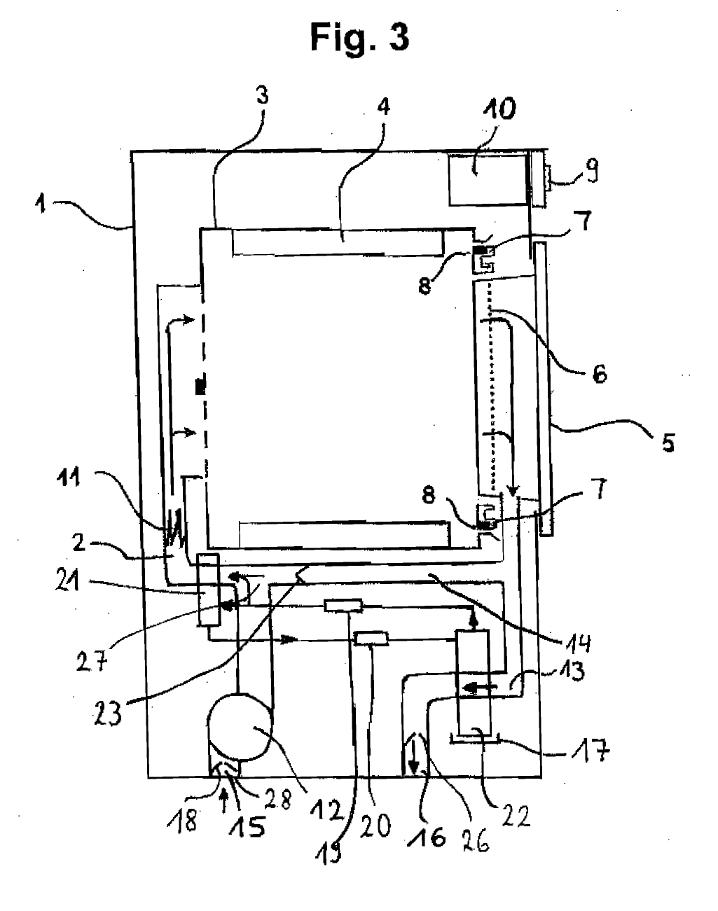

In the second and third embodiments shown in FIGS. 2 and 3 the same parts are labeled by the same reference signs. Thus only the differences from the embodiment shown in FIG. 1 will be referred to below.

FIG. 2 shows a vertical section through a dryer according to a second embodiment, in which a condenser 21 is located between a point 27 connecting recirculating air duct 14 to inlet air duct 15 and an inlet air access 28. The fan 12 is arranged here directly before the drum 3. A vent opening 24, that can be opened and closed by means of a fourth controllable closure facility 25 branches off from the process air duct 2 between the connecting point 27 and the heater 11.

FIG. 3 shows a vertical section through a dryer according to a second embodiment, in which a point 27 connecting recirculating air duct 14 to inlet air duct 15 is located between a condenser 21 and an inlet air access 28. This means that the third exemplary embodiment only differs from the second exemplary embodiment through the location of the placement of the condenser.

What is claimed:

1. A dryer comprising:
a drying chamber for the items to be dried;
an inlet air duct;
a process air duct;
an exhaust air duct;
a recirculating air duct;
a fan; and
a heat pump with an evaporator, a condenser and a programmable controller, wherein the dryer defines a process air path for obtaining and maintaining a predetermined minimum difference ΔTₛₑₜ between an evaporator entry temperature T₂ and a dryer entry temperature T₁ as well as a predetermined lower threshold T₂^{set} for the evaporator entry temperature.

2. The dryer of claim 1, wherein the process air path comprises a point between the condenser and an inlet air access connecting the recirculating air duct to the inlet air duct.

3. The dryer of claim 1, wherein the condenser is between a point connecting recirculating air duct to inlet air duct and an inlet air access.

4. The dryer of claim 1, wherein the process air duct comprises a vent opening before the drying chamber.

5. The dryer of claim 1, wherein the process air path has a condensation efficiency of at least 70%.

6. The dryer of claim 1, further comprising an electrical heater.

7. The dryer of claim 1, wherein the evaporator contacts the exhaust air duct.

8. The dryer of claim 1, further comprising a first controllable closure facility in the recirculating air duct.

9. The dryer of claim 8, further comprising a second controllable closure facility in the inlet air duct.

10. A method for operating a dryer with a drying chamber for the items to be dried, an inlet air duct, a process air duct, an exhaust air duct, a recirculating air duct, a fan, a heat pump with an evaporator and a condenser, a programmable controller, the drying defining a process air path for obtaining and maintaining a predeterminable minimum difference ΔT^{set} between an evaporator entry temperature T₂ and a dryer entry temperature T₁ as well as a predetermined lower threshold T₂^{set} for the evaporator entry temperature, the method comprising:
conveying process air through the inlet air duct, the evaporator and the drying chamber; and
splitting off into a first part air flow in the recirculating air duct and into a second part air flow in the exhaust air duct such that a minimum difference ΔT^{set}=(T₂−T₁) is obtained and maintained between an evaporator entry temperature T₂ and a dryer entry temperature T₁ and a predetermined lower threshold T₂^{set} for the evaporator entry temperature is obtained and maintained.

11. The method of claim 10, wherein a volume ratio between the first part air flow and the second part air flow ranges from 1.5 to 10.

12. The method of claim 11, wherein the volume ratio between the first part air flow and the second part air flow ranges from 3 to 8.

13. The method of claim 10, wherein the first part air flow amounts to 200 to 300 m³/h and the second part air flow is less than 100 m³/h.

14. The method of claim 10, further comprising opening an outlet vent to achieve the minimum difference ΔT^{set}=(T₂−T₁) and a lower threshold T₂^{set} for the evaporator entry temperature.
